(19) United States
(12) Patent Application Publication
(10) Pub. No.: US 2003/0126135 A1
(43) Pub. Date: Jul. 3, 2003

(54) Remote resource management of local devices

(76) Inventors: David Gaxiola, San Jose, CA (US); Joseph Alexander Dara-Abrams, Los Altos, CA (US); Ravi Gauba, Fremont, CA (US); Jun Ouyang, Sunnyvale, CA (US); Klaus Hofrichter, Santa Clara, CA (US)

Correspondence Address: Andre M. Gibbs, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/040,504

(22) Filed: Dec. 28, 2001

(51) Int. Cl. G06F 7/00

(52) U.S. Cl. 707/10

(57) ABSTRACT

Remote resource management of local devices through a remote resource management service provider is described. The remote resource management service provider performs resource management operations on a local device upon an indication that resource management on the local device is necessary to perform a specific service.

### FIELD OF THE INVENTION

The present invention relates generally to the provision of personalized home network services. More particularly the invention relates to remote management of resources on a home network.

### BACKGROUND

The broad availability of Internet access over dial-up, Digital Subscriber Line (DSL), or cable networks, as well as other network technology such as Digital Television (DTV) broadcast or wireless services, expand the capabilities of shared services between new consumer electronic devices. Typically, these devices require certain software to be loaded. The loaded software enables the device to take advantage of an offered service. For example, the software may provide services to upload digital images from a camera to a printing service, to send messages from a PDA to a message board, or to request stock or weather information for display on a TV.

A problem arises since there are potentially many services that require different and possibly incompatible software on the device. It is also likely that the device may have a limited amount of storage space to execute the loaded software or can only handle a limited amount of software components. Therefore, it is difficult for users to keep track of the software that is installed, and to decide which are the most relevant to keep in case a conflict arises.

### SUMMARY OF THE INVENTION

Remote resource management of local devices through a remote resource management service provider. The remote resource management service provider performs resource management operations on a local device upon an indication that resource management on the local device is necessary to perform a specific service.

### BRIEF DESCRIPTION OF THE DRAWINGS

The present invention is illustrated by way of example and not intended to be limited by the figures of the accompanying drawings in which like references indicate similar elements and in which:

FIG. 1 shows a system architecture of one embodiment of a home network of the present invention.

FIG. 2 shows functionalities of one embodiment of a custom settings manager in the home network of FIG. 1.

FIG. 3 is a flow diagram illustrating interactions in one embodiment of the home network of FIG. 1.

FIG. 4 shows an exemplary computer system suitable for providing resource management in which the present invention may be implemented.

### DETAILED DESCRIPTION

In one embodiment, a resource management service provider performs resource management operations to allocate resources (e.g., storage and memory space, software, among other examples) on a specific device in a home network. Whether to perform a resource management operation may be based on user usage patterns or current resource levels for the device as will be further described below. In this way, a resource management operation may provide proactive countermeasures to efficiently allocate resources on a device before a service is executed.

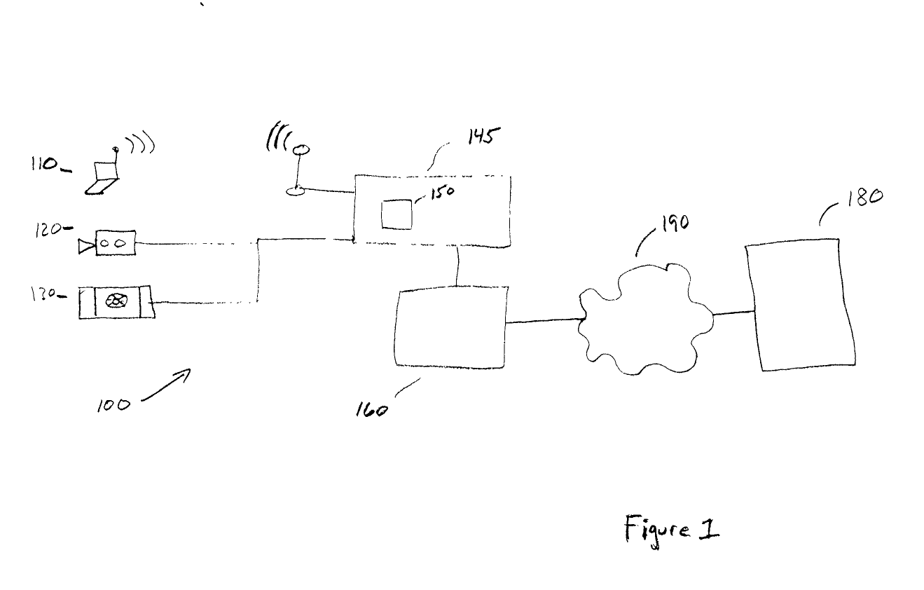

FIG. 1 illustrates one embodiment of a home network in which a shared network access device 160, a set top box 145, and multiple consumer electronic devices 110, 120, 130 are coupled to the home network 100. The shared network access device 160 is a network access device that is shared by devices on the home network 100 and further coupled to a service provider 180 via an external network 190, such as cable, satellite or the Internet. The shared network access device 160 may include a television, a DVD player, a stereo system, a cable modem, or other processing system that presents programming, such as broadcast programming, programming on media, and/or programming received from the external network(s) based on the user preferences described further below. In one embodiment, the shared network access device 160 and set top box 145 are physically combined into one device.

The home network 100 may provide one or more services to the devices 110, 120, 130 coupled to the home network. A service may be an application that is accessible by a user locally on a directly connected device, or remotely across a network. For example, a user may prefer using a particular service (e.g., a graphical editing service) when utilizing a particular device (e.g., a graphics tablet). The service may be embodied as software code or data, used or executed by the coupled device or another device, such as the set top box 145.

Devices 110, 120, 130 may be directly or indirectly coupled to the home network 100. The devices 110, 120, 130 are illustrated as a cellular telephone 110, a digital camera 120, or a digital audio player 130 but the invention is not so limited. Custom settings manager 150 communicates with devices 110, 120, 130 through the home network 100.

In one embodiment, a custom settings manager 150 detects the coupling of a device to the home network 100. Upon detecting the presence of the device on the home network 100, the custom settings manager 150 may select the appropriate configuration options based on combinations of devices and services in use at a particular time.

In one embodiment, a resource management service provider 180 provides for the allocation of resources on a coupled device. Although the following describes the service provider 180 as a server remote from the home network 100, in alternative embodiments, the service provider 180 may be resident on the home network 100, set top box 145, or the devices 110, 120, 130.

In one embodiment, the service provider 180 is identifies existing or future resource management needs. When necessary, the service provider 180 may prompt the user with suggestions about how to avoid conflicts, or the service provider 180 may take proactive countermeasures to efficiently allocate resources. For example, the service provider 180 may analyze the usage of specific content files or software components on a device. If an existing content file is not used, or is very rarely used, the service provider 180 may suggest removing the file, or transferring it to a different location to make room for other content. In another example, a frequently used content file could be transferred to the device in anticipation of its use, thereby saving subsequent access time. The transfer of the content can be performed transparently to the user, thereby providing seamless resource management. Content file or software component that is to be removed can be stored locally or remotely to be retrieved at a later time. It should be appreciated that this allows a user to utilize a device with a limited amount of memory and storage space.

In another embodiment, the service provider 180 determines to provide necessary resource management upon analyzing the usage patterns of a user of a device. The service provider 180 may identify usage consumption patterns by accessing the log information of the services used on the device. For example, if a wireless PDA with limited amount of memory or storage space is used in the morning for review of news, and in the evening for gaming purposes, a service provider 180 can identify this usage pattern and become proactive by storing content according to the expected usage pattern.

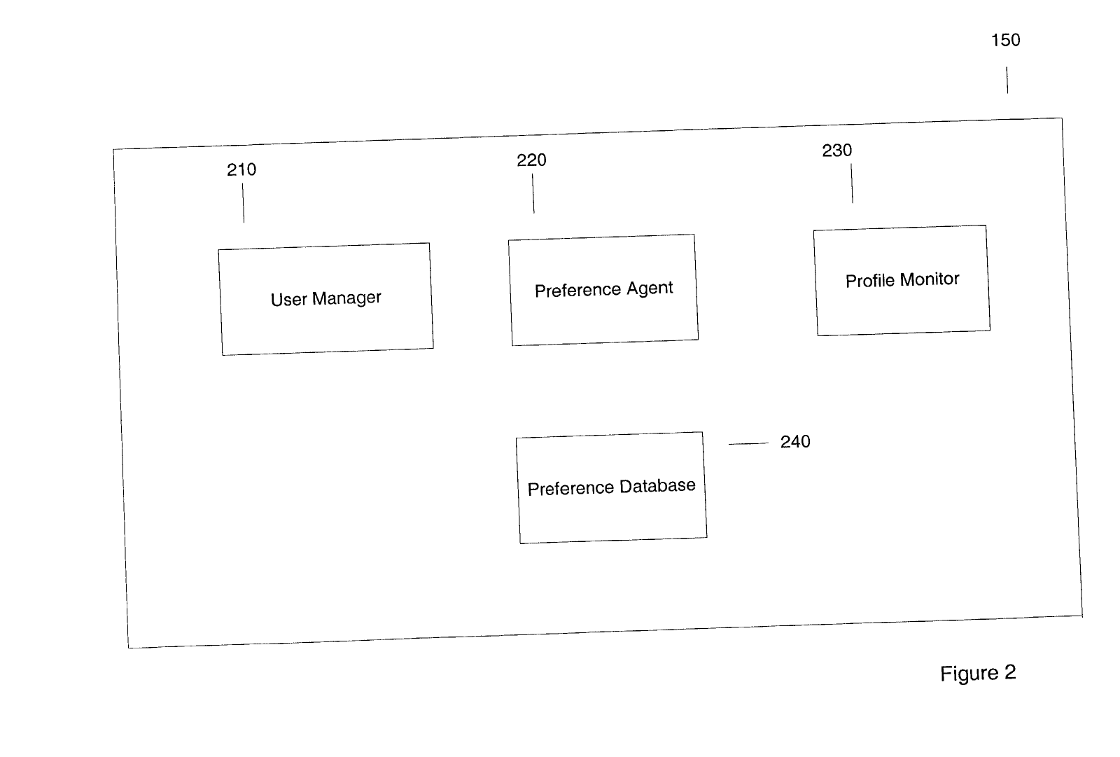

FIG. 2 shows exemplary functionalities of the custom settings manager, including a preference database 240, a user manager 210, a profile monitor 230, and a preference agent 220. The preference database 240 stores a user profile for each user of the home network 100. Each user profile contains user preferences information for each device and/or service. The user preferences are used to customize specific devices and services on the home network 100.

The user manager 210 detects the presence of a new device on the network and determines who is the owner or primary user of the device. The preference agent 220 is used to apply specific user preferences to a specific device. The profile monitor 230 monitors the allocation of resources on a device coupled to the home network 100. Such resources include the available storage and memory space, the current utilization of services on a device (e.g., software versioning), among other examples. Depending on the resources available, the profile monitor 230 communicates with the service provider 180 to perform resource management operations on the device.

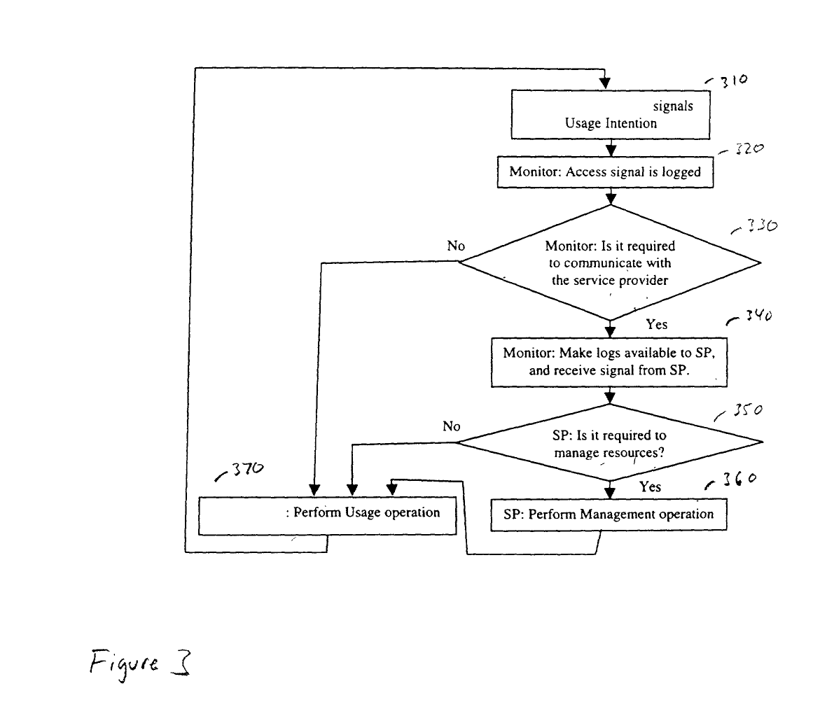

A flow diagram illustrating one embodiment of interactions between the custom settings manager 150 and the service provider 180 is shown in FIG. 3. At block 310, a service usage intention signal is received by the user manager 210 from a device coupled to the home network 100. That is, the device signals an intention to use a specific service (e.g., a graphical editing service) on a specific device. The device (e.g., OS) or specific service/application may initiate the service usage intention signal.

At block 320, the usage intention signal is logged by the profile monitor 230 as service log information. The service log information provides a history of a user's usage patterns and is stored in the user profile of the specific user in the preference database 240.

At block 330, the profile monitor 230 determines if communication with the service provider 180 is necessary before the requested service is performed. Communication with the service provider 180 may be necessary if a resource management operation is needed. If communication with the service provider 180 is needed, control passes to block 340. If communication with the service provider 180 is not needed, at block 370, the device performs the service indicated by the usage intention signal and also a usage operation is performed.

In block 340, communication with a service provider 180 is initiated and the service log information is transferred to the service provider 180 from the profile monitor 230. In this way, the service provider 180 may use its own processing capabilities to analyze the long-term usage history of the user of the device based on the service log information.

At block 350, if a resource management operation is necessary, control passes to block 360. If a resource management operation is not necessary, control passes to block 370 as described above.

At block 360, the service provider 180 performs a resource management operation. Depending upon the usage intention signal, a resource management operation may include the reallocating of memory or storage space. The process of reallocating memory or storage may include unloading software components or content files on the device that are rarely used, preventing the installation of new software on the device if it would compromise the use of more relevant services, updating software to the latest version, among other examples. The service provider 180 may directly interface with the device to perform the resource management operation or may indirectly perform the resource management operation by providing instructions to a local proxy (e.g., the custom settings manager 150, device operating system, SNMP agent, etc.). Upon completion of performing the resource management operation, control is passed to the device at block 370, as described above.

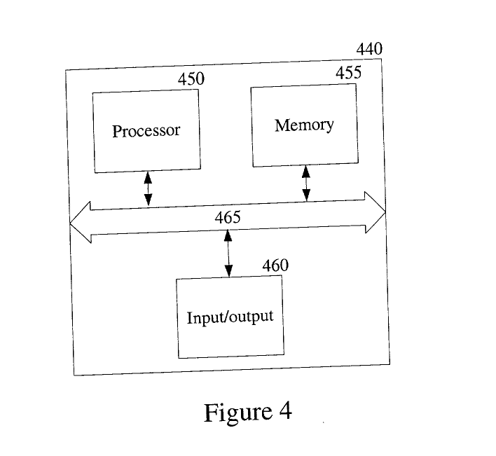

One embodiment of a computer system suitable for providing resource management is illustrated in FIG. 4. The computer system 440 includes a processor 450, memory 455 and input/output capability 460 coupled to a system bus 465. The memory 455 is configured to store instructions which, when executed by the processor 450, perform the methods described herein. The memory 455 may also store user profiles containing various usage patterns and user preferences. Input/output 460 provides for the delivery and display of software to a device and allows for the modification of the user profiles and user preferences thereof. Input/output 460 also encompasses various types of machine-readable media, including any type of storage device (e.g., preference database 240) that is accessible by the processor 450.

The description of FIG. 4 is intended to provide an overview of computer hardware and other operating components suitable for implementing the invention, but is not intended to limit the applicable environments. It will be appreciated that the computer system 440 is one example of many possible computer systems which have different architectures. A typical computer system will usually include at least a processor, memory, and a bus coupling the memory to the processor. One of skill in the art will immediately appreciate that the invention can be practiced with other computer system configurations, including multiprocessor systems, minicomputers, mainframe computers, and the like. The invention can also be practiced in distributed computing environments where tasks are performed by remote processing devices that are linked through a communications network.

It will be appreciated that that more or fewer processes may be incorporated into the method illustrated in FIG. 3 without departing from the scope of the invention and that no particular order is implied by the arrangement of blocks shown and described herein. It further will be appreciated that the method described in conjunction with FIG. 3 may be embodied in machine-executable instructions, e.g. software. The instructions can be used to cause a general-purpose or special-purpose processor that is programmed with the instructions to perform the operations described. Alternatively, the operations might be performed by specific hardware components that contain hardwired logic for performing the operations, or by any combination of programmed computer components and custom hardware components. The method may be provided as a computer program product that may include a machine-readable medium having stored thereon instructions which may be used to program a computer (or other electronic devices) to perform the method. For the purposes of this specification, the terms “machine-readable medium” shall be taken to include any medium that is capable of storing or encoding a sequence of instructions for execution by the machine and that cause the machine to perform any one of the methodologies of the present invention. The term “machine-readable medium” shall accordingly be taken to included, but not be limited to, solid-state memories, optical and magnetic disks, and a carrier wave that encodes a data signal. Furthermore, it is common in the art to speak of software, in one form or another (e.g., program, procedure, process, application, module, logic . . . ), as taking an action or causing a result. Such expressions are merely a shorthand way of saying that execution of the software by a computer causes the processor of the computer to perform an action or a produce a result.

In the foregoing specification, the invention has been described with reference to specific exemplary embodiments thereof. It will however, be evident that various modifications and changes may be made thereto without departing from the broader spirit and scope of the invention as set forth in the appended claims. The specification and drawings are, accordingly, to be regarded in an illustrative rather than a restrictive sense.

What is claimed is:

1. A method comprising:
receiving a communication that a service is to be used on a remote device;
determining whether to perform a resource management operation on the remote device in response to the communication; and
performing the resource management operation on the remote device.

2. The method of claim 1 wherein the receiving comprises receiving service log information.

3. The method of claim 2 wherein the determining comprises analyzing the service log information to determine a usage pattern of a user of the remote device.

4. The method of claim 1 wherein the determining comprises analyzing the amount of memory space on the remote device.

5. The method of claim 1 wherein the determining comprises analyzing the amount of storage space on the remote device.

6. The method of claim 1 wherein the performing resource management comprises unloading a software component from the remote device.

7. The method of claim 1 wherein performing resource management comprises unloading a content file from the remote device.

8. The method of claim 1 wherein the performing resource management comprises unloading a conflicting software component.

9. The method of claim 1 wherein the performing resource management comprises preventing installation of a software component.

10. A method comprising:
receiving an usage intention signal from a remote device, the usage intention signal indicating a service to be executed on the remote device;
determining whether to communicate with a remote service provider that performs a resource management operation on the remote device in response to the usage intention signal; and
communicating with the remote service provider to perform a resource management operation.

11. The method of claim 13 wherein the determining whether to communicate is based on a resource available on the remote device.

12. The method of claim 14 wherein the resource comprises a memory space.

13. The method of claim 14 wherein the resource comprises a storage space.

14. The method of claim 13 further comprising: collecting service log information, the service log information to be used to analyze a usage pattern.

15. The method of claim 16 wherein the service log information is stored in a user preference database.

16. The method of claim 16 wherein the communicating comprises providing the service log information to the service provider.

17. A system, comprising:
a local device coupled to a network, the local device including a service; and
a remote service provider to perform a resource management operation upon a resource event.

18. The system of claim 19 wherein the remote service provider analyzes a resource on the local device to determine whether to perform the resource management operation.

19. The system of claim 19 wherein the remote service provider analyzes the resource selected from the group consisting of a memory space and a storage space.

20. The system of claim 19 wherein the perform the resource management operation comprises unloading a software component from the local device.

21. The system of claim 19 wherein the perform the resource management operation comprises unloading a content file from the local device.

22. The system of claim 19 wherein the perform the resource management operation comprises unloading a conflicting software component.

23. The system of claim 19 wherein the perform the resource management operation comprises preventing the install of a software component.

24. The system of claim 19 wherein the remote service provider analyzes usage patterns to determine whether to perform the resource management operation.

25. The system of claim 20 wherein the usage patterns are stored in a preference database.

26. The system of claim 19 further comprising:
a profile monitor to receive a signal of the coupling of the local device and to communicate with the remote service provider to perform the resource management operation.

27. The system of claim 28 wherein the communication with the remote service provider comprises providing service log information to the remote service provider.

28. A machine-readable medium having executable instructions to cause a machine to perform a method comprising:
receiving a communication that a service is to be used on a remote device;
determining whether to perform a resource management operation on the remote device in response to the communication; and
performing the resource management operation on the remote device.

29. The machine-readable medium of claim 30 wherein the receiving comprises receiving service log information.

30. The machine-readable medium of claim 31 wherein the determining comprises analyzing the service log information to determine a usage pattern of a user of the remote device.

31. The machine-readable medium of claim 30 wherein the determining comprises analyzing the amount of memory space on the remote device.

32. The machine-readable medium of claim 30 wherein the determining comprises analyzing the amount of storage space on the remote device.

33. The machine-readable medium of claim 30 wherein the performing resource management comprises unloading a software component from the remote device.

34. The machine-readable medium of claim 30 wherein performing resource management comprises unloading a content file from the remote device.

35. The machine-readable medium of claim 30 wherein the performing resource management comprises unloading a conflicting software component.

36. The machine-readable medium of claim 30 wherein the performing resource management comprises preventing installation of a software component.

37. A machine-readable medium having executable instructions to cause a machine to perform a method comprising:
receiving an usage intention signal from a remote device, the usage intention signal indicating a service to be executed on the remote device;
determining whether to communicate with a remote service provider that performs a resource management operation on the remote device in response to the usage intention signal; and
communicating with the remote service provider to perform a resource management operation.

38. The machine-readable medium of claim 41 wherein the determining whether to communicate is based on a resource available on the remote device.

39. The machine-readable medium of claim 41 wherein the resource comprises a memory space.

40. The machine-readable medium of claim 41 wherein the resource comprises a storage space.

41. The machine-readable medium of claim 41 further comprising: collecting service log information, the service log information to be used to analyze a usage pattern.

42. The machine-readable medium of claim 45 wherein the service log information is stored in a user preference database.

43. The machine-readable medium of claim 45 wherein the communicating comprises providing the service log information to the service provider.
